(19) United States
(12) Patent Application Publication
(10) Pub. No.: US 2025/0238649 A1
(43) Pub. Date: Jul. 24, 2025

(54) PHYSICAL OBJECT, PHYSICAL MANAGEMENT ARCHITECTURE, AND PHYSICAL MANAGEMENT METHOD FOR DIGITAL ASSET

(71) Applicants: CHI-CHING CHEN, NEW TAIPEI CITY (TW); NET ALLIANCE CO., LTD., NEW TAIPEI CITY (TW)

(72) Inventor: CHI-CHING CHEN, NEW TAIPEI CITY (TW)

(21) Appl. No.: 18/751,607

(22) Filed: Jun. 24, 2024

(30) Foreign Application Priority Data
Jan. 23, 2024 (TW) 113102564

(51) Int. Cl. G06K 19/07; G06K 19/077; G06Q 20/34

(52) U.S. Cl. CPC G06K 19/0723; G06K 19/07749; G06Q 20/346; G06Q 2220/00

(57) ABSTRACT

This disclosure provides a physical management architecture for digital asset, which comprises a physical object transformed from a digital asset, a guarantee card, and a computing device. The physical object is configured with a first wireless sensing chip having a first internal code. The guarantee card is configured with a second wireless sensing chip having a second internal code. The computing device obtains the first internal code by reading the first wireless sensing chip, and obtains the second internal code by reading the second wireless sensing chip. When the first internal code corresponds to the second internal code, the computing device indicates that the physical object is a legally authorized and manufactured object. When the first internal code does not correspond to the second internal code, the computing device indicates that the physical object is an unauthorized and illegal manufactured object.

This non-provisional application claims priority claim under 35 U.S.C. § 119 (a) on Taiwan Patent Application No. 113102564 filed Jan. 23, 2024, the entire contents of which are incorporated herein by reference.

### FIELD OF THE INVENTION

The disclosure relates to an architecture and a method for transforming a digital asset into a physical object, and managing the physical object of the digital asset.

### BACKGROUND

A Non-fungible Token (NFT) is a unit of data that lives on a blockchain. The difference between NFT and homogeneous cryptocurrencies such as Bitcoin or Ethercoin in their non-fungible nature, where each NFT possesses unique and non-interchangeable characteristics. Therefore, each NFT can be used to represent unique digital data and serve as an electronic certification or digital credential for ownership of a virtual commodity. Due to its non-fungible nature, each NFT can also represent a digital asset such as artwork, collectibles, sound, video, in-game items, or other forms of creative works. The digital assets represented by NFTs are often traded using Bitcoin or Ethercoin as the unit of pricing.

The digital assets represented by NFTs can be treated as virtual commodities and traded on NFT marketplaces. Common NFT marketplaces include platforms such as OpenSea, Blur, X2Y2, LooksRare, Oursong, Lootex, and others. NFT issuers can sell the digital assets represented by NFTs on these platforms, while NFT holders can engage in buying and selling, as well as bidding on NFT digital assets within these NFT marketplaces.

Furthermore, there are several common risks associated with investing in NFTs. Firstly, NFT is a digital data whose characteristics can be easily copied. Today's largest NFT trader (OpenSea) publicly acknowledged on Twitter that over 80% of the digital assets represented by NFTs on their platform are counterfeit or plagiarized. Although NFT traders invest resources in fighting counterfeiting, it is still difficult to prevent the emergence of counterfeit goods.

Every industry wants a piece of the NFT pie. If the issuers of NFTs are merely following the trend to release digital assets, there is a high risk of announcing withdrawal or facing closure from the NFT market. In such cases, the digital assets of NFTs purchased from them not only may depreciate but also could lead to ownership disputes.

In addition, the digital assets of NFTs are easily maliciously bid up price. For example, issuers or holders can use multiple accounts to change hands multiple times to raise the selling price, so that the final purchase investors have a lot of problems. There is a high chance of buying an NFT that has no market.

Due to the aforementioned factors, the authenticity and ownership of digital assets in current NFTs cannot be effectively verified, and their transaction processes and prices are easily susceptible to forgery and manipulation. Nowadays, there is significant investment risks associated with using NFT digital assets as investment targets.

### SUMMARY

It is one objective of the disclosure to provide a physical object associated with a digital asset, wherein the digital asset represented by a non-fungible token (NFT) can be transformed into the physical object by a printing device of a digital asset management center. The physical object is configured with a first wireless sensing chip. The first wireless sensing chip stores a first information and a first internal code. The first information is a basic information of the digital asset. The first information and the first internal code are embedded into a first signal with high or ultra-high frequency generated by the first wireless sensing chip. A signal reader can read the first signal generated by the first wireless sensing chip to obtain the first information and the first internal code. In this way, the NFT's digital asset is brought into the real world in a physical form, and becomes a decoration or collectible that can be physically displayed. This is done to enhance the collectible value of the NFT's digital asset and to provide tangible proof of ownership for the digital asset represented by the physical object.

It is one objective of the disclosure to provide a physical management architecture for digital asset, wherein the printing device of the digital asset management center further prints a guarantee card related to the physical object of the digital asset. The guarantee card records a basic information of the physical object on a front and/or a back surface of its card body. A second wireless sensing chip is configured on the guarantee card. The second wireless sensing chip stores a second information and a second internal code. The second information is a basic information of the digital. The second information and the second internal code are embedded into a second signal with high or ultra-high frequency generated by the second wireless sensing chip. After the physical object and the guarantee card have been manufactured, an administrator of the digital asset management center hands over both the physical object and the guarantee card to the creator or owner of the digital asset.

It is another objective of the disclosure to provide a physical management architecture for digital asset, wherein a consumer or a collector of the physical object can submit both the physical object and the guarantee card to the digital asset management center so as to verify the authenticity of the physical object through the digital asset management center. The digital asset management center is configured with a computing device and a signal reader. The computing device of the digital asset management center reads the first signal generated by the first wireless sensing chip of the physical object via the signal reader to obtain the first internal code, and reads the second signal generated by the second wireless sensing chip of the guarantee card via the signal reader to obtain the second internal code. After obtaining the first internal code and the second internal code, the computing device of the digital asset management center compares whether the first internal code corresponds to the second internal code. If the first internal code corresponds to the second internal code, the computing device indicates that the physical object is a legally authorized and manufactured object. On the contrary, if the first internal code does not correspond to the second internal code, the computing device indicates that the physical object is an unauthorized and illegal manufactured object. In this way, the digital asset management center can not only manufacture the physical object associated with the digital asset with the legal authorization of the creator or owner of the digital asset, but also provide a service for verifying the authenticity of the physical object, so as to reduce the possibility of the illegally manufactured physical object circulating in the market.

To achieve the above objective, the disclosure provide a physical object for digital asset, which is manufactured by a digital asset management center printing a digital asset through a printing device, comprising: a first wireless sensing chip, being a chip that can be sensed at close proximity, used for generating a first signal, and comprising a first memory element; wherein the first memory element stores a first information and a first internal code, the first information and the first internal code are embedded in the first signal generated by the first wireless sensing chip; wherein the first information comprises a basic information of the digital asset; wherein a signal reader obtains the first information and the first internal code by reading the first signal generated by the first wireless sensing chip.

In one embodiment of the disclosure, the first wireless sensing chip is a radio frequency identification chip or a near field communication chip.

In one embodiment of the disclosure, the digital asset is represented by a non-fungible token.

In one embodiment of the disclosure, the basic information of the digital asset comprises creation name, file properties, creator, or owner of the digital asset.

In one embodiment of the disclosure, the basic information of the digital asset also includes transaction records related with the digital asset or the physical object.

The disclosure further provides a physical management architecture for digital asset, comprising: a physical object manufactured by a digital asset management center printing a digital asset through a printing device, wherein the physical object comprises a first wireless sensing chip that is used for generating a first signal, and comprises a first memory element, the first memory element stores a first information and a first internal code, the first information and the first internal code are embedded in the first signal generated by the first wireless sensing chip; a guarantee card, used to record a basic information about the physical object on a surface of its card body, and comprising a second wireless sensor chip that is used for generating a second signal, and comprises a second memory element; wherein the second memory element stores a second information and a second internal code, the second information and the second internal code are embedded in the second signal generated by the second wireless sensing chip; and a computing device, connected to a signal reader, obtained the first internal code by the signal reader reading the first signal generated by the first wireless sensing chip, and obtained the second internal code by the signal reader reading the second signal generated by the second wireless sensing chip; wherein the computing device compares whether the first internal code corresponds to the second internal code; when the first internal code corresponds to the second internal code, the computing device indicates that the physical object is a legally authorized object; otherwise, when the first internal code does not correspond to the second internal code, the computing device indicates that the physical object is an unauthorized object.

In one embodiment of the disclosure, the computing device and the signal reader are configured in the digital asset management center.

The disclosure further provides a physical management method for digital asset, comprising: manufacturing a physical object by a digital asset management center printing a digital asset through a printing device; configuring a first wireless sensing chip on the physical object; embedding a first internal code into a first signal generated by the first wireless sensing chip; providing a guarantee card; configuring a second wireless sensing chip on the guarantee card; embedding a second internal code into a second signal generated by the second wireless sensing chip; obtaining the first internal code by a signal reader reading the first signal generated by the first wireless sensing chip; obtaining the second internal code by the signal reader reading the second signal generated by the second wireless sensing chip; and indicating that the physical object is a legally authorized and manufactured object when the computing device compares that the first internal code corresponds to the second internal code or indicating that the physical object is an unauthorized and illegal manufactured object when the computing device compares that the first internal code does not correspond to the second internal code.

### BRIEF DESCRIPTION OF THE DRAWINGS

FIG. 1 is a schematic diagram of a digital asset management system of the disclosure.

FIG. 2 is an architecture diagram illustrating a process of identifying an authenticity of an object physicalized by a digital asset in the disclosure.

FIG. 3 is a flow chart illustrating a process of transforming the digital asset into the physical object in the disclosure.

FIG. 4 is a flow chart illustrating a process of identifying an authenticity of the object physicalized by the digital asset in the disclosure.

### DETAILED DESCRIPTION OF THE PREFERRED EMBODIMENTS

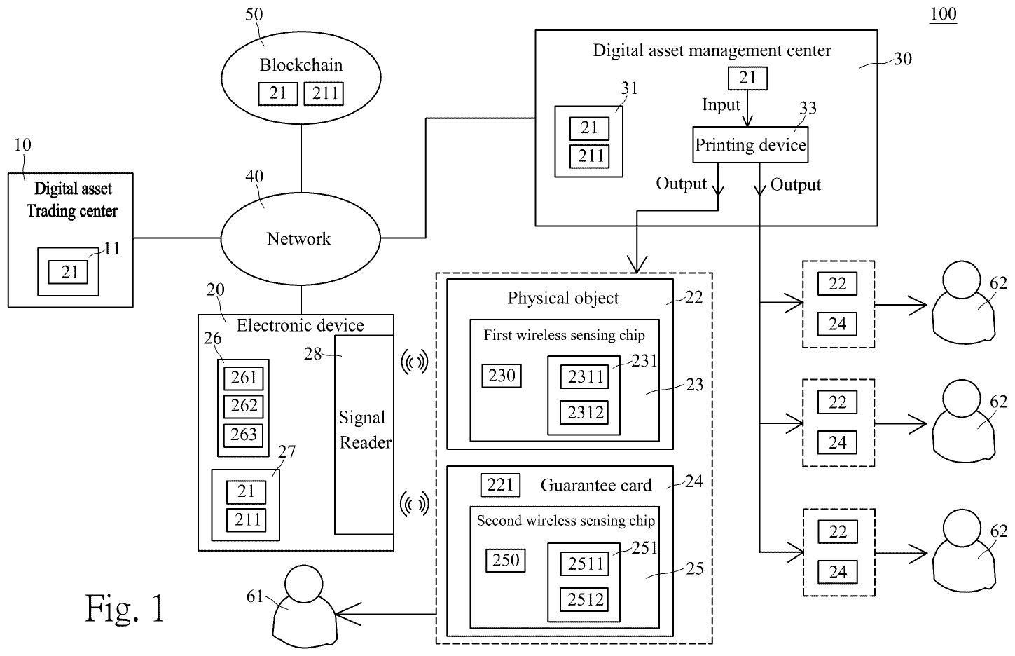

Referring to FIG. 1, there is shown a schematic diagram of a digital asset management system of the disclosure. As shown in FIG. 1, a digital asset management system 100 comprises a digital asset trading center 10 and a digital asset management center 30. An electronic device 20 used by a user 61 is connected to the digital asset trading center 10, the digital asset management center 30, and a block chain 50 via a network 40. The electronic device 20 can be a smart phone, a notebook computer, a desktop computer or a device with computing and data storage functions.

The digital asset trading center 10 is a platform capable of trading a digital asset 21. In the disclosure, the user 61 is creator or owner of the digital asset 21. The digital asset 21 is an image, a video clip, a piece of music (lyrics or sheet music), a tweet, or any creative work in digital form. In the disclosure, the digital asset 21 will be represented by a non-fungible token (NFT), and recorded in a distributed ledger of the block chain 50 in NTF form. The electronic device 20 comprises an electronic wallet 26, for example, NFT cryptocurrency wallet. The electronic wallet 26 comprises a public key 261, a private key 262, and an address 263. The address 263 recorded in the electronic wallet 26 can be a storage address of Bitcoin, Ethereum or NFT on the block chain 50.

The user 61 submits an application of a trading account 11 to the digital asset trading center 10. The trading account 11 is an account for trading the digital asset 21, and linked to the electronic wallet 26. The user 61 engages in the buying or bidding of the digital asset 21 represented by NTF on the digital asset trading center 10 through the trading account 11 and the electronic wallet 26.

In one embodiment of the disclosure, the digital asset 21 of NTF traded from the digital asset trading center 10 is stored in a data storage unit 27 (such as a data hard disk or a memory card) of the electronic device 20. In further embodiment of the disclosure, the digital asset 21 of NFT traded from the digital asset trading center 10 will be chained to the block chain 50. In another embodiment of the disclosure, the digital asset 21 of NTF traded from the digital asset trading center 10 will be stored in a data server or an interplanetary file system (IPFS).

The digital asset management center 30 is a unit that can execute the physicalizing process of the digital asset 21 and the certifying of the digital asset 21 physicalized. The user 61 submits an application for a supervision account 31 to the digital asset management center 31 with an identity document or an identity certificate. The supervision account 31 records the identity information of the user 61. In one embodiment of the disclosure, when the user 61 wants to transform the digital asset 21 from a digital form into a physical form, the electronic device 20 used by the user 61 can transmit the digital asset 21 and a basic information 211 of the digital asset 21 that are stored in the data storage unit 27 to the digital asset management center 30, so that the digital asset management center 30 can directly receive the digital asset 21 and the basic information 211 of the digital asset 21. In another embodiment of the disclosure, when the user 61 wants to transform the digital asset 21 from the digital form into the physical form, the electronic device 20 used by the user 61 can transmit a network link (URL link), an IPFS node or a block chain address that stores the digital asset 21 to the digital asset management center 30, and then the digital asset management center 30 can download the digital asset 21 and the basic information 211 thereof from the network link (URL link), the IPFS node or the block chain address. In the disclosure, the basic information 211 of the digital asset 21 comprises creation name, file properties, creator, or owner of the digital asset.

After obtaining the digital asset 21 and the basic information 211 thereof, the digital asset management center 30 stores the digital asset 21 and the basic information 211 thereof to the supervision account 31 belonging to the user 61, and prints the digital asset 21 to create a physical object 22 by the printing device 33. In the disclosure, the printing device 31 may be a 2D or 3D printing device used to print the digital asset 21 into a 2D or 3D physical object 22. The physical object 22 of the digital asset 21 may also be a printed artwork, a three-dimensional doll, a puzzle, a T-shirt or other printed object.

During the production process of the physical object 22 of the digital asset 21, a first wireless sensing chip 23 is disposed on the physical object 22 of the digital asset 21. The first wireless sensing chip 23 is a chip, such as radio frequency identification (RFID) chip or near field communication (NFC) chip, which can be sensed at close proximity and used for generating a first signal 230 at a first specific frequency. The first wireless sensing chip 23 comprises a first memory element 231. The first memory element 231 stores a first information 2311. The first information 2311 is embedded in the first signal 230 generated by the first wireless sensing chip 23. In the disclosure, the first information 2311 comprises the basic information 211 of the digital asset 22, for example, the digital asset's creation name, file attributes, creator, or owner, etc.

Furthermore, the digital asset management center 30 uses the printing device 33 to create a guarantee card 24 associated with the physical object 22 of the digital asset 21. The guarantee card 24 is a physical card that records a basic information 221 of the physical object 22 on a front and/or a back surface of its card body. The basic information 221 of the physical object 22 can include details such as the name of the physical object 22, the time of its creation, the name of the creator of the digital asset 21, or other relevant information. Besides, a second wireless sensing chip 25 is disposed on the guarantee card 24. The second wireless sensing chip 25 is also a chip, such as an RFID or NFC chip, capable of being sensed at close proximity and used for generating a second signal 250 at a second specific frequency. The second wireless sensing chip 25 comprises a second memory element 251, for example, the first memory element 231 and the second memory element 251 can be Non-Volatile Memories (NVMs). The second memory element 251 stores a second information 2511. The second information 2511 is embedded in the second signal 250 generated by the second wireless sensing chip 25. In the disclosure, the second information 2511 comprises the basic information 211 of the digital asset 22, for example, the digital asset's creation name, file attributes, creator, or owner, etc.

After the physical object 22 and the guarantee card 24 have been manufactured, administrator of the digital asset management center 30 hands the physical object 22 and the guarantee card 24 together to the user 61. Subsequently, when the user 61 or any third party wishes to query the basic information 211 of the digital asset 21 associated with the physical object 22, they can use a signal reader 28 in the electronic device 20 or a mobile device to read the first signal 230 generated by the first wireless sensing chip 23 of the physical object 22 or read the second signal 250 generated by the second wireless sensing chip 25 of the guarantee card 24. The signal reader 28 may be an RFID tag reader or NFC tag reader. After reading the first signal 230 or the second signal 250, the signal reader 28 parses the first information 2311 or the second information 2511 from the first signal 230 or the second signal 250, and then displays the first information 2311 or the second information 2511 on a monitor of the electronic device 20 or the mobile device. Thus, the user 61 or any third party can know the details about the digital asset 21, such as its creation name, file attributes, creator, or owner, by displaying the first information 2311 or the second information 2511 on the monitor of the electronic device 20 or the mobile device.

In this way, the NFT's digital asset 21 is brought into the real world in a physical form, and becomes a decoration or collectible that can be physically displayed. This is done to enhance the collectible value of the NFT's digital asset 21 and to provide tangible proof of ownership for the digital asset 21 represented by the physical object 22. Besides, after manufacturing the physical object 22, the digital asset management center 30 also attaches a guarantee card 24, so as to effectively authenticate the ownership of the NFT's digital asset 21 and its physical object 22 through the guarantee card 24.

The digital asset management center 30 can additionally mass-produce the physical objects 22 with the authorization of the creator or owner of the digital asset 21. Subsequently, these physical objects 22, accompanied by guarantee cards 24, can be sold to consumers 62. This approach aims to enhance the commercial value of the digital asset 21.

Furthermore, the basic information 211 of the digital asset 21 also includes transaction records related to the digital asset 21 and/or the physical object 22. When the digital asset 21 and/or the physical object 22 wants to be transacted, by the transaction records related to the digital asset 21 and/or the physical object 22, the transaction prices of the digital asset 21 and/or the physical object 22 will be prevented from being arbitrarily inflated. This ensures that consumers can purchase the digital asset 21 and/or the physical object 22 at a fair price.

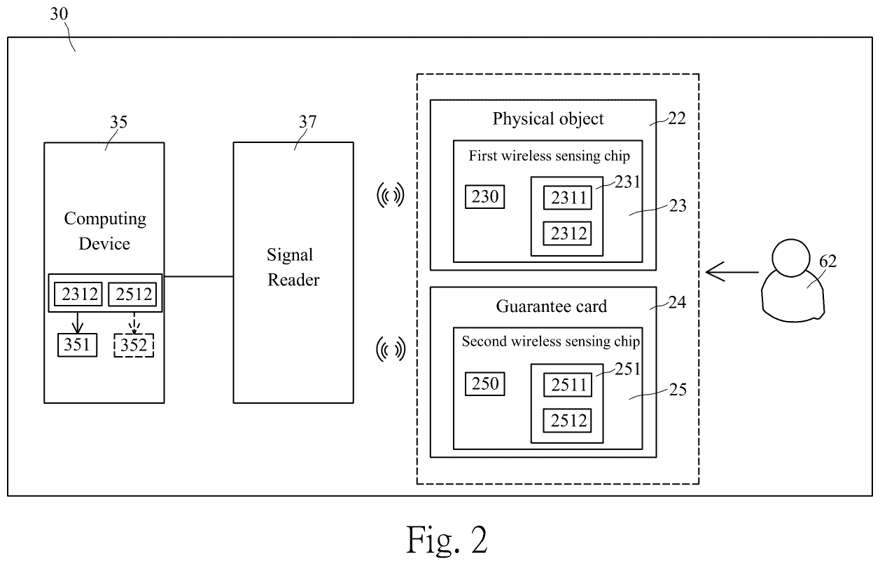

Referring to FIG. 2, there is shown an architecture diagram illustrating a process of identifying an authenticity of an object physicalized by a digital asset in the disclosure. As shown in FIG. 2, the first memory element 231 of the first wireless sensing chip 23 of the physical object 22 stores a first internal code 2312, and the second memory element 251 of the second wireless sensing chip 25 of the guarantee card 24 stores a second internal code 2512. The first internal code 2312 may be embedded in the first signal 230 generated by the first wireless sensing chip 23, and the second internal code 2512 may be embedded in the second signal 250 generated by the second wireless sensing chip 25. In the disclosure, the second internal code 2512 is preset to correspond to the first internal code 2312.

To prevent the purchase or collection of counterfeit physical object 22, the consumer 62 of the physical object 22 or the collector of the physical object 22 can submit both the physical object 22 and the guarantee card 24 to the digital asset management center 30 so as to verify the authenticity of the physical object 22 through the digital asset management center 30.

The digital asset management center 30 is configured with a computing device 35 and a signal reader 37 connected to the computing device 35. The computing device 35 may be a desktop computer, a notebook computer, a handheld computing device or a device with functions of computing and data storage capabilities. The signal reader 37 (such as RFID or NFC tag reader) is an independent device or an internal component provided in the computing device 35.

The computing device 35 reads the first signal 230 generated by the first wireless sensing chip 23 of the physical object 22 via the signal reader 37 to obtain the first internal code 2312, and reads the second signal 250 generated by the second wireless sensing chip 25 of the guarantee card 24 via the signal reader 37 to obtain the second internal code 2512. After obtaining the first internal code 2312 and the second internal code 2512, the computing device 35 of the digital asset management center 30 compares whether the first internal code 2312 corresponds to the second internal code 2512. If the first internal code 2312 corresponds to the second internal code 2512, the computing device 35 issues a first indication signal 351 to indicate that the physical object 22 is a legally authorized object manufactured by the digital asset management center 30 with the permission of the creator or owner of the digital asset 21. On the contrary, if the first internal code 2312 does not correspond to the second internal code 2512, the computing device 35 issues a second indication signal 352 to indicate that the physical object 22 is an unauthorized object manufactured without the permission of the creator or owner of the digital asset 21. In the disclosure, the first indication signal 351 or the second indication signal 352 will be presented on a display or an audio player of the computing device 35 in the form of a text, a picture or a sound.

In this way, the digital asset management center 30 can not only manufacture the physical object 22 associated with the digital asset 21 with the legal authorization of the creator or owner of the digital asset 21, but also provide a service for verifying the authenticity of the physical object 22, so as to reduce the possibility of the illegally manufactured physical object 22 circulating in the market.

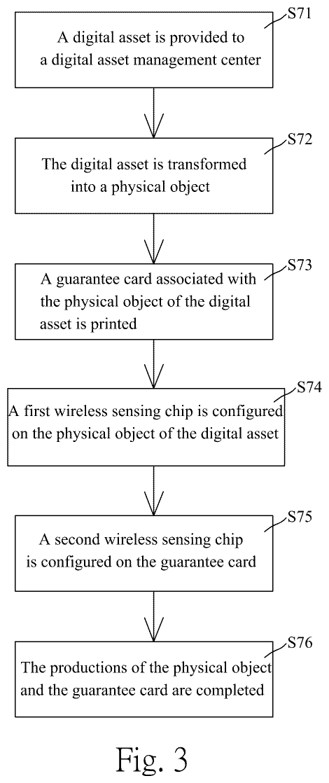

Referring to FIG. 3, there is shown a flow chart illustrating a process of transforming the digital asset into the physical object in the disclosure. As shown in FIG. 3, firstly, in step S71, the creator or owner of the digital asset 21 provides the digital asset 21 to the digital asset management center 30. In step S72, the digital asset management center 30 transforms the digital asset 21 into a 2D or 3D physical object 22 by the printing device 33. In step S73, the digital asset management center 30 prints a guarantee card 24 associated with the physical object 22 by the printing device 33. In step S74, a first wireless sensing chip 23 is configured on the physical object 22. A first information 2311, including a basic information 211 of the digital asset 21 and a first internal code 2312, can be embedded into a first signal 230 generated by the first wireless sensing chip 23. In step S75, a second wireless sensing chip 25 is configured on the guarantee card 24. A second information 2511, including the basic information 211 of the digital asset 21 and a second internal code 2512, can be embedded into a second signal 250 generated by the second wireless sensing chip 25. In step S76, once the physical object 22 and the guarantee card 24 has been manufactured, the administrator of the digital asset management center 30 hands over both the physical object 22 and the guarantee card 24 to the creator or owner of the digital asset 21; alternatively, the administrator of the digital asset management center 30 may sell the physical object 22 along with the guarantee card 24 to a consumer.

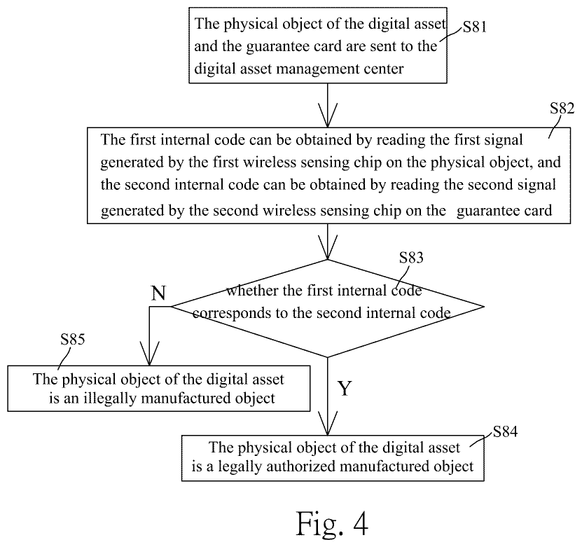

Referring to FIG. 4, there is shown a flow chart illustrating a process of identifying an authenticity of the object physicalized by the digital asset in the disclosure. As shown in FIG. 4, firstly, in step S81, the physical object 22, along with the guarantee card 24, is sent to the digital asset management center 30. In step S82, a computing device 35 disposed in the digital asset management center 30 reads the first signal 230 generated by the first wireless sensing chip 23 of the physical object 22 via a signal reader 37 to obtain the first internal code 2312 of the first information 2311, and reads the second signal 250 generated by the second wireless sensing chip 25 of the guarantee card 24 via the signal reader 37 to obtain the second internal code 2512 of the second information 2511. In step S83, the computing device 35 compares whether the first internal code 2312 corresponds to the second internal code 2512. If the first internal code 2312 corresponds to the second internal code 2512, step S84 is executed, the computing device 35 indicates that the physical object 22 is a legally authorized and manufactured object. On the contrary, if the first internal code 2312 does not correspond to the second internal code 2512, step S85 is executed, the computing device 35 indicates that the physical object 22 is an unauthorized and illegal manufactured object.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

1. A physical object for digital asset, which is manufactured by a digital asset management center printing a digital asset through a printing device, comprising:
a first wireless sensing chip, being a chip that can be sensed at close proximity, and comprising a first memory element;
wherein the first memory element stores a first information and a first internal code, the first information and the first internal code are embedded in a first signal generated by the first wireless sensing chip;
wherein the first information comprises a basic information of the digital asset;
wherein a signal reader obtains the first information and the first internal code by reading the first signal generated by the first wireless sensing chip.

2. The physical object for digital asset according to claim 1, wherein the first wireless sensing chip is a radio frequency identification chip or a near field communication chip.

3. The physical object for digital asset according to claim 1, wherein the digital asset is represented by a non-fungible token.

4. The physical object for digital asset according to claim 1, wherein the basic information of the digital asset comprises creation name, file properties, creator, or owner of the digital asset.

5. The physical object for digital asset according to claim 4, wherein the basic information of the digital asset also includes transaction records related with the digital asset or the physical object.

6. A physical management architecture for digital asset, comprising:
a physical object manufactured by a digital asset management center printing a digital asset through a printing device, wherein the physical object comprises a first wireless sensing chip that is used for generating a first signal, and comprises a first memory element, the first memory element stores a first information and a first internal code, the first information and the first internal code are embedded in the first signal generated by the first wireless sensing chip;
a guarantee card, used to record a basic information about the physical object on a surface of its card body, and comprising a second wireless sensor chip that is used for generating a second signal, and comprises a second memory element; wherein the second memory element stores a second information and a second internal code, the second information and the second internal code are embedded in the second signal generated by the second wireless sensing chip; and
a computing device, connected to a signal reader, obtained the first internal code by the signal reader reading the first signal generated by the first wireless sensing chip, and obtained the second internal code by the signal reader reading the second signal generated by the second wireless sensing chip;
wherein the computing device compares whether the first internal code corresponds to the second internal code; when the first internal code corresponds to the second internal code, the computing device indicates that the physical object is a legally authorized object; otherwise, when the first internal code does not correspond to the second internal code, the computing device indicates that the physical object is an unauthorized object.

7. The physical management architecture for digital asset according to claim 6, wherein the first wireless sensing chip and the second wireless sensing chip are a radio frequency identification chip or a near field communication chip, respectively.

8. The physical management architecture for digital asset according to claim 6, wherein the digital asset is represented by a non-fungible token.

9. The physical management architecture for digital asset according to claim 6, wherein the computing device and the signal reader are configured in the digital asset management center.

10. A physical management method for digital asset, comprising:
manufacturing a physical object by printing a digital asset through a printing device;
configuring a first wireless sensing chip on the physical object;
embedding a first internal code into a first signal generated by the first wireless sensing chip;
providing a guarantee card;
configuring a second wireless sensing chip on the guarantee card;
embedding a second internal code into a second signal generated by the second wireless sensing chip;
obtaining the first internal code by a signal reader reading the first signal generated by the first wireless sensing chip;
obtaining the second internal code by the signal reader reading the second signal generated by the second wireless sensing chip; and
indicating that the physical object is a legally authorized and manufactured object when the computing device compares that the first internal code corresponds to the second internal code or indicating that the physical object is an unauthorized and illegal manufactured object when the computing device compares that the first internal code does not correspond to the second internal code.
